(19) United States
(12) Patent Application Publication
(10) Pub. No.: US 2007/0147317 A1
(43) Pub. Date: Jun. 28, 2007

(54) Method and system for providing differentiated network service in WLAN

(75) Inventors: Brian K. Smith, Wellington, FL (US); Satish Ramprasad, Boynton Beach, FL (US); Srinath Subramanian, Davie, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/318,119

(22) Filed: Dec. 23, 2005

(51) Int. Cl. H04Q 7/24

(52) U.S. Cl. 370/338

(57) ABSTRACT

A system (100) and method (700) is provided for extending a standby battery life of a WLAN station (102) within a WLAN. The method can include creating an extended service area containing at least two access points (APs) (104/105), monitoring beacon frames and conducting neighbor AP scans for identifying the types of available network service areas, recognizing at least one service area within the extended service area, and connecting the WLAN station to the service area (103) using an AP network type, where the AP network type selection can be based on the traffic mode.

### FIELD OF THE INVENTION

The embodiments herein relate generally to methods and systems for wireless communications, and more particularly wireless networking.

### DESCRIPTION OF THE RELATED ART

IEEE 802.11 specifies a wireless local area network (WLAN) standard developed by the Institute of Electrical and Electronic Engineering (IEEE) committee. The standard does not generally specify technology or implementation but provides specifications for the physical (PHY) layer and Media Access Control (MAC) layer. The standard allows for manufacturers of WLAN radio equipment to build interoperable network equipment.

IEEE 802.11 provides for two modes of operation: ad-hoc and infrastructure mode. In ad-hoc mode, two or more WLAN stations can communicate using beacons in a peer-to-peer fashion. In infrastructure mode, an access point (AP) provides network connectivity to the WLAN stations to form a Basic Service Set (BSS). Multiple APs can form an Extended Service Set (ESS) to extend or enhance the coverage area of a WLAN.

A WLAN station discovers a WLAN through active or passive scanning of the WLAN channels for the presence of APs. To perform a passive scan, a WLAN station listens for Beacon frame transmissions from the APs on each WLAN channel. Beacon frames may contain a global or direct Service Set Identifier (SSID) which uniquely identifies a WLAN. Beacon frames are transmitted at the Beacon Interval which is a static, configurable parameter specifying the time interval between beacon frame transmissions from an AP. To perform an active scan, a wireless station transmits a Probe Request on each WLAN channel. The Probe Request may contain a global or direct SSID. The AP transmits a Probe Response with a direct SSID to the WLAN station. Upon discovery of a WLAN, the WLAN stations complete the authentication, association and security exchanges with the AP.

A WLAN station can operate in an Active or Power Save (PS) Mode on a WLAN. When in Active Mode, the WLAN station continuously monitors the WLAN channel for broadcast, multicast and unicast frames. In PS Mode, the WLAN station monitors Beacon frames only for buffered traffic indications from the AP.

A WLAN station in Active Mode is able to receive and transmit frames on the WLAN channel with low latency. Since the WLAN station is continuously monitoring the WLAN channel, the rate of power consumption is high which reduces the WLAN station's battery life.

A WLAN station in PS Mode monitors Beacon frames for indications concerning data buffered at the AP. The WLAN station can monitor Beacon transmissions from an AP at the Beacon Interval (i.e. 102.4 ms) or at a Delivery Traffic Indication Message (DTIM) Beacon Interval (i.e. 3×102.4=307.2 ms). To maximize a WLAN station's battery life, the WLAN station is generally configured to wake up to receive DTIM Beacons only. The WLAN station consumes a significant amount of current to monitor DTIM Beacons.

A WLAN station is able to handover to other APs within an ESS for various reasons that can include signal quality (i.e. RSSI), AP loading and location. To perform a handover, the WLAN station populates and maintains a site list of neighbor APs. New sites are added to the site list by performing a periodic active or passive scan of the WLAN channels for new neighbor APs. All sites are updated in the site list by performing a periodic active or passive scan of the WLAN channels for the known neighbor APs. The Scan Interval specifies the time between performing scans for neighbor APs.

The Beacon Interval, DTIM Period and the Scan Interval have a dominant impact on the WLAN station's battery life.

### SUMMARY

The embodiments of the invention concern a method for providing differentiated network service in an overlay WLAN. The method can include identifying a traffic mode, scanning for at least one Access Point, categorizing a plurality of Access Points, and selecting an Access Point based on an AP network type. The traffic mode corresponds to a current operating mode of a WLAN station. The AP network type identifies the configuration of an AP for supporting a particular traffic mode.

In one aspect, a WLAN station can monitor Beacon frames and conduct neighbor AP scans to identify types of available network service areas. The WLAN station can identify an AP network type from a Beacon Interval field and a DTIM Period field within a Beacon Frame. An AP network type can be a power-save network, a high-speed network, a voice network, and a low-latency network. The WLAN station can rank Access Points as a function of an AP network type in a site list.

A WLAN station can request an AP network type, and identify at least one AP in the site list that supports the requested AP network type. The WLAN station can go through the list in an ordered manner looking for an AP that satisfies the traffic mode requirements of the WLAN station. The AP network type can correspond to a power save requirement, a data throughput requirement or a quality of service. For example, the WLAN station can connect to an AP in the site list supporting the AP network type that provides the data throughput of the available network service.

Embodiments of the invention also concern a system for providing differentiated network service. The system can include an overlay WLAN including at least two access points (APs), and a WLAN station configured to switch to an AP based on a power save operation of the WLAN station. The power save operation adjusts Beacon Intervals, DTIM Periods and neighbor AP Scan Intervals for conserving standby battery life of the WLAN station. The overlay WLAN can be created by defining a single AP to behave as multiple APs, or adding additional APs to said overlay WLAN with the same SSID. The WLAN station can be pre-programmed with a set of scan intervals that are switched in view of the AP network type.

Embodiments of the invention also concern a method of operation in a power save optimized overlay WLAN. The method can include receiving a Beacon Frame from an AP, parsing a Beacon Interval, and a DTIM Period from the Beacon Frame, identifying a type of available network service area in view of the information within the Beacon Frame, and associating the type of available network service area with an AP network type.

The method can further include determining a traffic mode, ranking a plurality of APs according to the AP network type, selecting an AP network type in view of the traffic mode, and switching to an AP in view of the ranking to support the traffic mode. The ranking can sort the plurality of APs in order of data throughput capabilities. In another example, the ranking can further include sorting a site list based on a power-save mode of an AP. Switching can include handing off from a first AP to a second AP as a requirement of the traffic mode changes. For example, an AP can be selected that satisfies the data throughput requirements of the traffic mode. The traffic mode can include at least one adjustable configuration such as a Scan Interval, a DTIM Period, or a Beacon Interval. The method can further include creating an extended service area to support a high-speed network, a data network, a voice network, or a power-save network.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a system for a wireless local area network in accordance with an embodiment of the inventive arrangements;

FIG. 2 depicts a WLAN with a single AP in accordance with an embodiment of the inventive arrangements;

FIG. 3 depicts a WLAN with an overlay AP in accordance with an embodiment of the inventive arrangements;

FIG. 4 presents an AP selection table in accordance with an embodiment of the inventive arrangements;

FIG. 5 depicts a WLAN site list in accordance with an embodiment of the inventive arrangements;

FIG. 6 is a WLAN site list in accordance with an embodiment of the inventive arrangements; and

FIG. 7 is a flow chart for a method for differentiated network service in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processor” can be defined as any number of suitable components that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The term traffic mode refers to the current operating mode of a WLAN station.

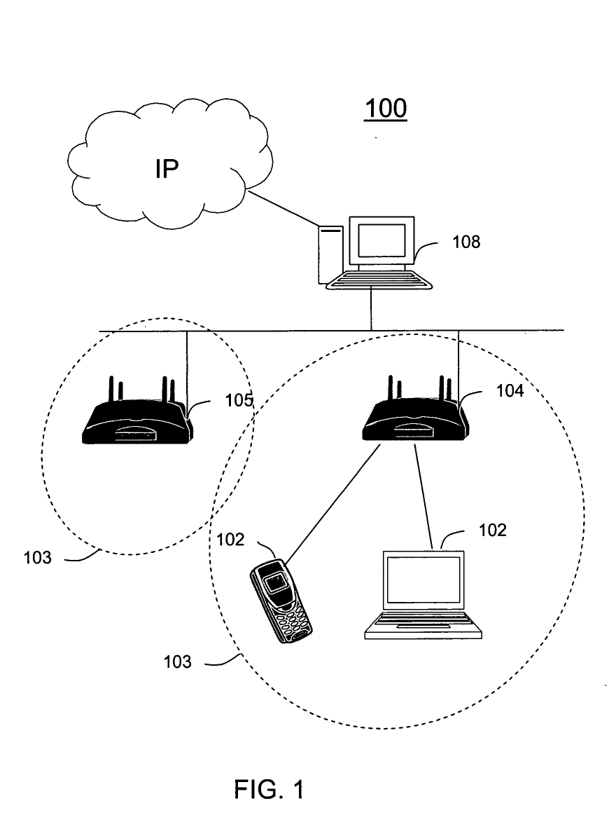

Referring to FIG. 1, a wireless local area network (WLAN) 100 is shown. The network 100 can include at least one WLAN station 102, and at least two Access points (APs) 104, also known as base stations, which can route to a communication infrastructure such as an IP network. Communication within the network 100 can be established using a wireless, copper wire, and/or fiber optic connection using any suitable protocol (e.g., TCP/IP, HTTP, etc.). The network 100 can comprise any type of network, such as a Local Area Network (LAN), a Metropolitan Area Network (MAN), a Wide Area Network (WAN), a Wireless LAN (WLAN), or other network. WLAN stations within the coverage area can connect to the network 100 to acquire Internet and/or another LAN, MAN, LAN, or WLAN services. The WLAN station 102 can be a desktop computer, laptop computer, handheld computer, palmtop computer, mobile phone, push-to-talk mobile radio, text messaging device, two way pager, one-way pager, or any other wireless communications enabled device. The WLAN station 102 can be equipped with a transmitter and receiver for communicating with the AP 104 according to the appropriate wireless communication standard. In one embodiment of the present invention, the wireless station 102 is equipped with an IEEE 802.11 compliant wireless medium access control (MAC) chipset for communicating with the AP 104

The network 100 can cover a geographical region called an extended service area (ESA) within which members of an extended service set (ESS) may communicate. Generally, a WLAN includes several basic service sets (BSSs), each with an associated AP 104 which controls communication within its basic service area (BSA) 103. Multiple basic service areas 103 can be interconnected to form an extended service area usually with a wired network typically using 802.3 LAN technologies. The APs 104 can communicate with an access router (AR) 108 to route traffic within and out of the network 100. Wireless stations 102 are allowed to roam within a defined basic service area 103 and across the overlapping basic service areas 103, with handover of the device from one AP to the adjoining AP in accordance to known procedures. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. Additional functions such as packet fragmentation, re-transmission, and acknowledgements, can be carried out by the 802.11 MAC layer.

When associating to an AP 104, a WLAN station 102 sends an Association Request or Re-association Request frame to the AP 104, where the request includes a Listen Interval. The Listen Interval indicates how often the WLAN station 102 wakes up to listen to Beacon frames when operating in a Power Save (PS) Mode. The AP 104 can buffer frames for the WLAN station 102 according to the indicated Listen Interval. The Beacon frame includes the Beacon Interval and the DTIM Period. The Beacon Interval indicates the number of time units (TUs) between target beacon transmission times (TBTTs). The DTIM Period multiplied by the Beacon Interval indicates the DTIM Beacon Interval. The WLAN station 102 can monitor Beacon frame transmissions from the AP 104 at the Beacon Interval (i.e. 102.4 ms) or at the DTIM Beacon Interval (i.e. 3×102.4 =307.2 ms). The WLAN station 102 can receive indications concerning buffered data available for the WLAN station 102 at the AP when a Beacon or DTIM Beacon is received.

A WLAN station 102 may operate in Power Save (PS) or Active Mode. In Active Mode, the WLAN station 102 is continuously monitoring the channel for broadcast, multicast and unicast frames. The AP 104 does not buffer any frames for the WLAN station 102. The AP 104 immediately transmits frames to the station upon arrival at the AP 104. In PS Mode, the WLAN station 102 is responsible for monitoring Beacon or DTIM Beacon frames for a buffered traffic indication. If the Beacon or DTIM Beacon frame indicates buffered frames for the WLAN station 102, the WLAN station 102 transmits a Power-Save (PS) Poll to the AP 104, to which the AP 104 responds by sending a frame of data to the WLAN station 102. If the WLAN station 102 is not within the service area for receiving the Beacon or DTIM Beacon frame, the AP 104 will discard the packets upon expiration of the Listen Interval.

A WLAN station 102 is able to toggle between Active and PS Modes when communicating with AP 104. In PS Mode, the WLAN station 102 is able to minimize current drain, but at the cost of an increase in packet latency. During PS Mode, the WLAN station 102 is able to shut down various WLAN subsystems such as the RF front end ICs to reduce current drain while waiting for a Beacon or DTIM Beacon frame. In Active Mode, the WLAN station 102 is able to minimize packet latency, but at a cost of a significant increase in current drain.

A WLAN station 102 such as a mobile phone must operate as much as possible in PS Mode to provide an acceptable battery life to the user. A WLAN station 102 must also provide satisfactory quality of service (QoS) when accessing the network. A trade-off between an acceptable battery life and satisfactory QoS can only be achieved by combining the Active and PS modes of the WLAN station 102.

The family of 802.11 standards provide a mechanism for a device to enter a Power Save (PS) Mode when in a low to no traffic state. To extend battery life, a WLAN can be configured as an overlay to optimize for power saving when a device is operating in PS mode. The overlay WLAN allows the device to handover between APs as the traffic requirements of the device toggle between various modes, such as power-save and low-latency. In an overlay arrangement, the AP can establish multiple stream paths for polling the AP with different priorities within the WLAN. For example, a device can request a service having high latency (low data rate) requirements, such as messaging or web browsing. Accordingly, the device can monitor Beacons at intervals according to a slower data rate, for polling the AP in a power save mode. Correspondingly, the device may request a service having low latency (high data rate) requirements such as voice, or combined data and voice. Accordingly, the device can monitor Beacons at intervals according to a low latency (higher rate), for polling data from the AP at a higher rate. However, with only a single AP, having a single Beacon and PS-polling stream, the WLAN stations are all required to operate with the same Beacon Interval and Scan Interval. An overlay, having multiple streams, can be pre-configured to each support a pre-established data rate, thereby supporting different service rate requirements. Less overhead can be required thereby preserving battery power.

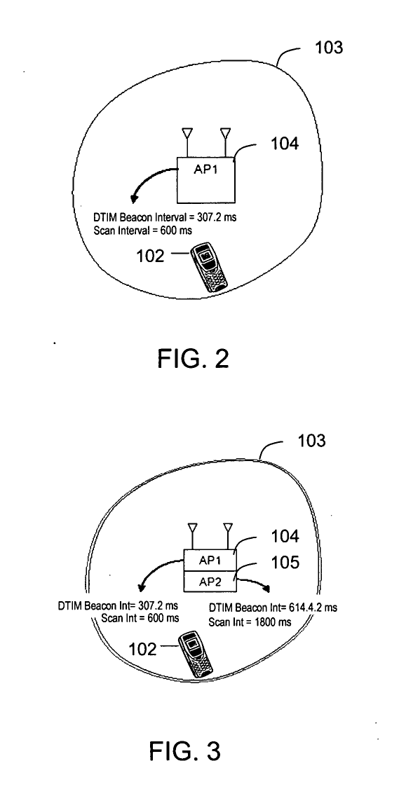

In a first arrangement, a single AP can be configured to behave as multiple APs for providing multiple communication streams. In a second arrangement, additional APs can be added to the WLAN with the same SSID, for providing multiple polling streams. Referring to FIG. 2, a WLAN with a single AP is shown. The single AP can be the AP 104 of FIG. 1. The single AP 104 can be configured as a software WLAN overlay. This can allow the single AP 104 to behave as multiple APs for extending the battery life of the WLAN station 102. The single AP 104 can be a single dedicated piece of hardware, such as a base station in a user's home, that provides 802.11 WLAN implementations. For example the AP 104 can enable internet connectivity or file sharing.

Software on the single AP 104 can be configured to support multiple streams thereby providing distinct Beacon and PS-polling streams using a single piece of hardware. The AP 104 can be configured to provide separate Beacon and PS-polling streams such that a WLAN station recognizes multiple ‘virtual’ APs though only a single AP is present. For example, a WLAN station can communicate with a first ‘virtual’ AP independently from a second ‘virtual’ AP. The single AP can support a software implementation for multiple APs using the same hardware, for example, by changing a configuration parameter on the AP. The single AP 104 is configured to create an instance of itself within software for accessing the same underlying hardware resources. The single configured AP provides separate and distinct beacon and PS-polling streams.

In a second arrangement, as shown in FIG. 3, at least two APs 104, 105, having separate hardware but configured with the same SSID, can be added to the WLAN 100 for providing multiple streaming behavior. Additional APs can be added to the ESS to increase the number of network service offerings. For example, a first AP can provide high speed data connectivity, a second AP can provide voice, and a third AP can provide multimedia streaming. The multiple APs are configured to extend the device's standby battery life by establishing separate Beacon and PS-polling streams. The WLAN station can switch between APs based on an AP network type for polling at different rates based on device requirements for conserving battery power. For example, when the WLAN station 102 originates a voice call, the WLAN station switches the AP network type to low latency and the WLAN station hands off to a low-latency AP. When the device ends a call, the WLAN station switches the AP network type to power-save and the device hands off to a power-save AP.

A different set of neighbor AP scan intervals can be used during power-save mode and low-latency mode. For example, when the WLAN station 102 changes to power-save mode, the scan intervals is increased for sending fewer probe requests thereby preserving power. Accordingly, the scan intervals are decreased in duration for sending more probe requests during low-latency. The WLAN station monitors neighbor APs for signal strength and link quality estimates at the scanning interval rate. The WLAN can hand over to another AP when the signal strength conditions are preferable for conserving battery power. The WLAN station 102 switches between APs for optimizing power consumption by switching the scan interval rate in accordance with the AP network type.

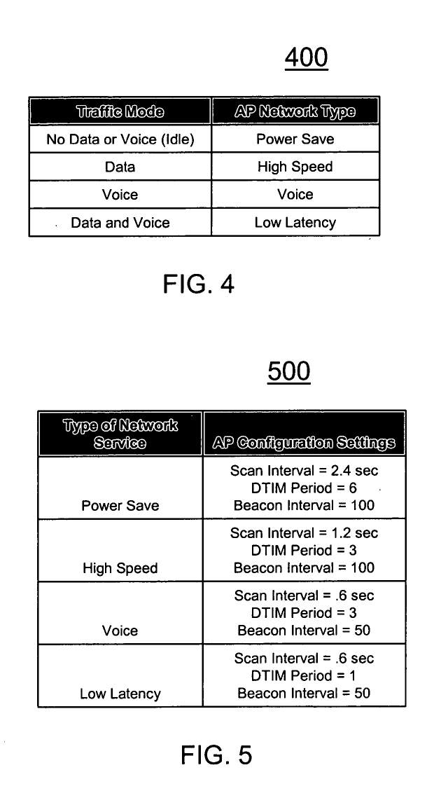

Referring to FIG. 4, an AP network mapping 400 relating traffic mode to AP network type is shown. Traffic Mode refers to the current operating mode of a WLAN station. The AP network type describes the configuration modes available to the WLAN station within the overlay WLAN. The WLAN station can determine its current operating mode and identify an AP network type that satisfies the data throughput requirements associated with the current operating mode. For example, referring to FIG. 1, the WLAN station 102 can operate in a low-latency mode when communicating with the AP 104 during a voice call. The WLAN station 102 can operate in a power-save mode when communicating with AP 105 in idle mode. The modes of operation are not limited to those shown, which serve only as example.

The WLAN station 102 ranks the neighbor APs within the WLAN 100 according to the AP network type as a function of the traffic mode in a site list. For example, referring to FIG. 4, ‘Idle’ is associated with power-save, ‘data’ is associated with high-speed, ‘voice’ is associated with low-latency, and the combination of ‘data and voice’ is associated with low-latency. When the WLAN station 102 transmits or receives traffic from an AP, it checks the traffic type (i.e. idle, data, voice, data and voice), and identifies the network type associated with the traffic mode for switching to the corresponding AP. The WLAN station 102 ranks the AP network type in the site list 400 by the types of available network service areas. The WLAN station 102 sorts the site list in order of a quality of service (e.g. traffic mode) and selects an AP at the top of the site list.

For example, during idle mode, a WLAN station 102 has an AP network type of power-save that is associated with a power-save AP. The WLAN station 102 can scan neighbor APs for other power-save APs as it moves between service areas or as the link qualities change. When the WLAN station 102 initiates a voice call, the WLAN station 102 switches AP network type from a power-save mode to a low-latency mode to support packet rates for the voice call. The WLAN station 102 ranks the AP network type according to the traffic mode, thereby placing priority on a low-latency mode for a voice call, and selects a low-latency AP. The WLAN station 102 hands off from a power-save AP to the low-latency AP selected. During the voice call, the WLAN station 102 continually updates the table 400 and switches between neighbor APs for optimizing low-latency. Notably, WLAN device 102 switches the scanning rate interval as the selection criteria is switched between idle mode and voice mode. When the device ends the call, the selection criteria is switched to idle mode and the WLAN station 102 hands off from the low-latency AP back to a power-save AP.

Referring to FIG. 5, an AP network configuration table 500 is shown. The AP network configuration table 500 relates an AP network type to a network configuration setting. For example, a power-save AP network type is associated with a Scan Interval=2.4 seconds, DTIM Period=6, and a Beacon Interval of 100 ms. A high-speed AP network type is associated with an Scan Interval=1.2 seconds, DTIM Period=3, and a Beacon Interval of 100 ms. A voice AP network type is associated with a Scan Interval=0.6 seconds, DTIM Period=3, and a Beacon Interval of 50 ms. A low-latency AP network type is associated with an Scan Interval=0.6 seconds, DTIM Period=1, and a Beacon Interval of 50 ms.

A WLAN station can refer to the AP network configuration table 500 to switch to a Scanning Interval, DTIM Period, or Beacon Interval rate in response to a traffic mode change. The WLAN station switches network configurations to comply with the AP network type selected for the traffic mode. For example, a WLAN device determines a traffic mode and selects an AP from a site table that supports the traffic mode. In order to support the traffic mode, the WLAN station adjusts a scanning interval, a DTIM period, and a beacon interval to communicate with the selected AP. The WLAN station can adjust various configuration parameters which are herein contemplated within embodiments of the invention. For example, during active mode the WLAN station sets AP configuration parameters in accordance with a high-speech, voice, or low-latency AP configuration setting. During PS-mode the WLAN station sets AP configuration parameters in accordance with a power-save AP configuration setting.

Accordingly, the WLAN station 102 is also pre-programmed with a set of scan intervals that are switched in view of the AP network type. For example, the WLAN station 102 changes the scan interval to a lower rate when the device enters power-save mode to conserve standby battery life. The WLAN station 102 hands off between various APs as the requirements of the WLAN station toggle between power save and low latency. In one aspect, the Scan Interval can be transmitted by the AP in a proprietary Information Element in a Beacon, Probe Response or Measurement Pilot frame.

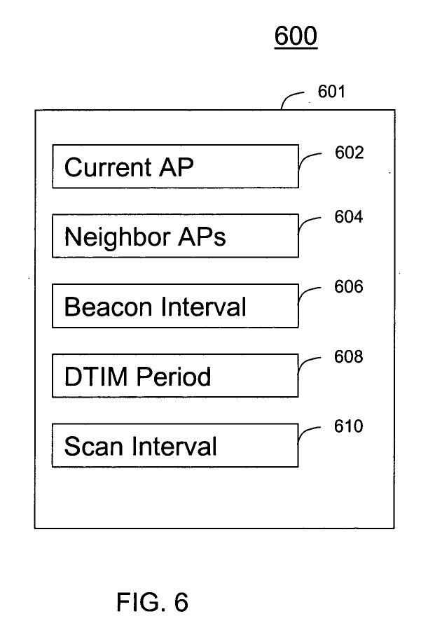

Referring to FIG. 6, a WLAN site list 600 is shown. The site list 600 can include a Current AP 602, a Neighbor AP list 604, a Beacon Interval field 606, a DTIM Period field 608, and a Scan Interval 610. The scan interval can be sent to a WLAN station in a Beacon frame as a proprietary Information Element (IE). The Current AP 602 reveals the AP with which the WLAN station 102 is currently associated. The neighbor AP list 604 presents the list of neighbor APs that are within service range of the WLAN station 102. The neighbor AP list 604 can be categorized by an AP network type, such as those shown in FIG. 4, i.e., power-save, high-speed, voice, low-latency. The WLAN station 102 scans the extended service area by sending out probe requests to identify neighbor APs. The WLAN station 102 can recognize a service area from a SSID within a Beacon Frame sent by a neighbor AP. The number of Beacon transmissions that the WLAN station 102 monitors has a large impact on the device's battery life.

The WLAN station 102 monitors Beacon Frames and switches neighbor AP scan intervals for conserving standby battery life. The monitoring includes parsing the Beacon Frame from an AP for identifying a traffic mode supported by the AP. For example, the WLAN station 102 identifies a power-save AP from a Beacon Interval and DTIM period within the Beacon Frame. For example, a traffic indication map (TIM) element in a Beacon Frame contains a DTIM period field. The DTIM Period field indicates the number of Beacon Intervals between successive DTIMs. The DTIM Period multiplied by the Beacon Interval indicates the DTIM Beacon Interval. The WLAN station 102 stores the Beacon Interval 606, the DTIM Period 608, and the Scan Interval 610 within the site list 600. The WLAN station identifies an AP by parsing the DTIM period to determine the traffic mode supported by the AP.

In general, the AP 104 transmits Beacon frames to identify the location and accessibility of the AP 104 to the WLAN station 102. The WLAN station 102 processes data from the AP 104 when it receives a Beacon Frame. The WLAN station 102 monitors Beacon transmissions transmitted by the Access Point (AP) 104 at the Beacon Interval (i.e. 102.4 ms) or at the Delivery Traffic Indication Message (DTIM) Beacon Interval (i.e. 3×102.4=307.2 ms) depending on the AP network type of FIG. 4. The Beacon Interval indicates the number of time units (TUs) between target beacon transmission times (TBTTs).

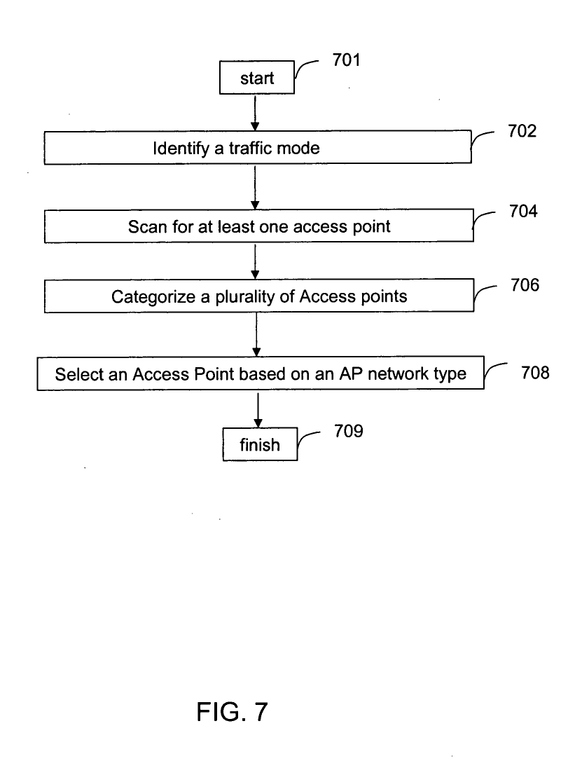

Referring to FIG. 7, a method 700 is shown for creating an AP selection table (FIG. 4) and switching to an AP for use with a power-save optimized overlay WLAN. Reference will be made to FIGS. 1, 4, and 5. The method 700 can be implemented in any other suitable device or system using other suitable components. Moreover, the method 700 is not limited to the order in which the steps are listed in the method 700. In addition, the method 300 can contain a greater or a fewer number of steps than those shown in FIG. 3.

At step 701, the method can start. At step 702, a traffic mode can be identified. For example, referring to FIG. 3, the WLAN station 102 determines the current operating mode. The operating mode can be idle, voice, data, or a combination of voice and data. At step 702, at least one access point can be scanned. For example, referring to FIG. 3, the WLAN station 102 scans for APs such as 104 and 105 within the overlay region 103. The WLAN station 102 perform a passive scan for Beacon Frames from the APs. The WLAN station parses Beacon Interval and DTIM period information from the Beacon Frame. The DTIM Period field indicates the number of Beacon Intervals between successive DTIMs. The WLAN station 102 determines AP network types by analyzing the information from the Beacons

At step 706, a plurality of Access points can be categorized. For example, referring to FIG. 3, the WLAN station 102 identifies APs within the overlay region 103 during scanning. The WLAN station categorizes the APs based on their AP network type in accordance with the traffic mode requirements of the WLAN station. Notably, the WLAN station ranks the APs in accordance with traffic mode requirements for identifying APs that satisfy the data throughput requirements of the traffic mode. The WLAN station 102 categorizes the APs by AP network type for selecting an AP that complies with the traffic mode requirements of the WLAN station. The WLAN station 102 ranks the APs in the site table 600 according to the AP network type and traffic mode.

At step 708, an Access Point based on an AP network type is selected. For example, referring to FIG. 3, a WLAN station 102 operating in an idle mode selects an AP within the overlay region 103 having an AP network type of power-save. Referring to FIG. 4, the AP network mapping 400 is presented for a WLAN station 102 in traffic mode. The AP network mappings 400 are contained within the site table 600 of FIG. 6. The site table categorizes neighbor APs by AP network mode and network configuration settings. Notably, the WLAN station 102 selects the AP in the site list 600 corresponding to the AP network type at the top of the table 400. Understandably, an AP meeting the traffic mode requirements may not be available within the overlay region 103 or the extended service area. Accordingly, the WLAN station 102 selects the next AP in the site table. The WLAN station 102 requests an AP network type, identifies at least one AP in the site list supporting the requested said AP network type, and connects to an AP associated with the AP network type for providing the available network service.

It would be apparent to one of ordinary skill in the art that the communication technologies illustrated in FIGS. 1-6 can be modified without departing from the scope of the claims. Changes to the 802.11 standard are not necessary for purposes of implementing the differentiated network service overlay WLAN. The network can support a single mode WLAN station, a dual mode WLAN station (i.e. WLAN+CDMA1X, GSM, or iDEN) without departing from the teachings of the present disclosure and the claims described herein.

Where applicable, the present embodiments can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A method for providing differentiated network service in an overlay WLAN comprising:
identifying a traffic mode;
scanning for at least one Access Point;
categorizing a plurality of Access points; and
selecting an Access Point based on an AP network type,
wherein a traffic mode corresponds to a current operating mode of a WLAN station.

2. The method of claim 1, wherein an AP network type associates an AP with a network configuration that supports at least one traffic mode.

3. The method of claim 1, wherein the scanning further comprises monitoring beacon frames and conducting neighbor AP scans for identifying types of available network service areas,

4. The method of claim 1, wherein categorizing further comprises ranking said plurality of Access Points by said AP network type in a site list.

5. The method of claim 4, wherein the selecting further comprises:
requesting an AP network type;
identifying at least one AP in the site list supporting the requested said AP network type; and
connecting to an AP associated with said AP network type for providing an available network service,
wherein the identifying includes starting at the top of the site list and moving down the site list.

6. The method of claim 1, wherein said WLAN station identifies an AP network type from a Beacon Interval field and a DTIM period field within a Beacon Frame.

7. The method of claim 1, wherein a traffic mode can be one from the group comprising: idle, data, voice, and, data and voice.

8. The method of claim 1, wherein an AP network type can be one from the group comprising: power-save, high-speed, voice, and low-latency.

9. The method of claim 1, wherein said overlay WLAN defines a single AP to behave as multiple APs, or adds APs to said overlay WLAN with the same SSID.

10. A system for providing differentiated network service comprising:
a WLAN station for communication with an overlay WLAN including a plurality of access points (APs) separately configured to have different Beacon Intervals and DTIM Periods; and
a processor coupled to the WLAN station, wherein the processor is programmed to:
scan for at least one Access Point;
categorize said plurality of Access points;
select an Access Point based on an AP network type; and
switch to an AP based on a Beacon Interval and DTIM Period for conserving standby battery life of said WLAN station

11. The system of claim 10, wherein said WLAN station is pre-programmed with a set of scan intervals that are switched in view of said AP network type.

12. The system of claim 10, wherein the processor monitors Beacon Frame transmissions and conducts neighbor AP scans for identifying types of available network service areas,

13. A method of operation in a power save optimized overlay WLAN comprising:
receiving a Beacon Frame from an AP;
parsing a Beacon Interval and a DTIM Period from said Beacon Frame;
identifying a type of available network service area from said Beacon Interval and DTIM Period; and
associating said type of available network service area with an AP network type.

14. The method of claim 13, further comprising:
determining a traffic mode;
ranking a plurality of APs according to said AP network type; and
selecting an AP network type in view of said traffic mode;
switching to an AP in view of said ranking to support said traffic mode.

15. The method of claim 14, wherein said ranking sorts said plurality of APs in order of data throughput capabilities.

16. The method of claim 14, wherein said ranking further includes sorting a site list based on a power-save mode of an AP.

17. The method of claim 14, wherein said traffic mode includes at least one adjustable configuration parameter from the group: Scan Interval, DTIM Period, and Beacon Interval.

18. The method of claim 14, wherein said switching includes handing off from a first AP to a second AP as a requirement of said traffic mode changes.

19. The method of claim 14, wherein said switching includes selecting an AP that satisfies the data throughput requirements of said traffic mode.

20. The method of claim 14, further comprising creating an extended service area that supports at least one from the group comprising: a high-speed network, a data network, a voice network, and a power-save network.
